(19) United States
(12) Patent Application Publication
(10) Pub. No.: US 2021/0117928 A1
(43) Pub. Date: Apr. 22, 2021

(54) CONTEXTUAL MEETING PARTICIPANT SUGGESTION PLATFORM

(71) Applicant: Microsoft Technology Licensing, LLC, Redmond, WA (US)

(72) Inventors: Rahul Gupta, Telangana (IN); Manish Kansal, Telangana (IN)

(21) Appl. No.: 16/655,825

(22) Filed: Oct. 17, 2019

(51) Int. Cl. G06Q 10/10; G06Q 10/06

(52) U.S. Cl. CPC G06Q 10/1095; G06Q 10/063114

(57) ABSTRACT

A participant suggestion service receives a user input to create a calendar event, as well as a user input indicative of parameters associated with the calendar event. Context parameters are obtained based upon the input parameters, and can include correlations between the input parameters and potential participants. A set of suggested participants is identified based upon the input parameters and the context parameters. The set of suggested participants is surfaced for interaction by the user.

### BACKGROUND

Computing systems are currently in wide use. Some such computing systems host servers that are accessed by users who use client devices. Such computers can be used by organizations, such as enterprise organizations, and other organizations.

Users of these types of computing systems often attempt to mark time on the calendar of other people, by scheduling a meeting, scheduling a telephone call, scheduling other appointments, etc. These types of systems can also work with electronic mail systems. Therefore, when a meeting organizer is scheduling a meeting with a plurality of different participants, the meeting organizer manually includes each of the meeting participants by typing the alias (e.g., the email alias), of each of the participants. When groups of people frequently meet together, meeting organizers often create a distribution list (or otherwise designate a group) and everyone on the distribution list is invited to the meeting.

There are also currently some auto-suggest tools. When the meeting organizer starts typing the participant name/alias, these types of tools suggest a participant based on a most recently used name or alias, and based on those names or aliases that have characters starting with the ones that the organizer begins to type.

The discussion above is merely provided for general background information and is not intended to be used as an aid in determining the scope of the claimed subject matter.

### SUMMARY

A participant suggestion service receives a user input to create a calendar event, as well as a user input indicative of parameters associated with the calendar event. Context parameters are obtained based upon the input parameters, and can include correlations between the input parameters and potential participants. A set of suggested participants is identified based upon the input parameters and the context parameters. The set of suggested participants is surfaced for interaction by the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a flow diagram illustrating the operation of an inference computing system, shown in FIG. 1, in generating inferences.

FIG. 3 is a flow diagram illustrating one example of the operation of a meeting creation service, illustrated in FIG. 1, in creating and persisting a meeting or calendar event.

FIG. 4 is a flow diagram showing one example of the operation of a meeting participant suggestion service, illustrated in FIG. 1, in suggesting meeting participants to a meeting organizer.

FIG. 5 is a block diagram showing one example of the architecture illustrated in FIG. 1, deployed in a cloud computing architecture.

FIGS. 6-8 show examples of mobile devices that can be used in the architectures shown in the previous figures.

FIG. 9 is a block diagram showing one example of a computing environment that can be used in the architectures shown in the previous figures.

### DETAILED DESCRIPTION

As discussed above, in current systems, the process of entering participants for a calendar event (which can be a meeting, a call, a collaboration session, etc.—all of which are referred to herein as a meeting) is a highly manual process. Even when distribution lists are created, the process of creating the distribution list, in itself is highly manual. Also, even when auto-suggest features are used, they often only suggest participants based upon letters that are initially, manually, typed by the meeting organizer.

This type of process is not only manually cumbersome and time consuming, but it is also error prone. It can lead to cases where a desired participant is missed, because he or she is not invited, as a participant, to the meeting. It can also lead to cases where extra participants are added to the meeting, when they do not need to attend, and when, in fact, their attendance is not desired. Inadvertently adding a participant may occur because the participant is part of a distribution list.

In addition, this conventional type of process of adding participants to a meeting is static. Therefore, for recurring meetings, the user must often modify the participants for each of the occurrences based upon the meeting agenda and topic. These problems become exacerbated when new members join a team, or project, or other group within an organization.

The present discussion thus proceeds with respect to a platform that receives a user input indicating that a meeting is to be scheduled. It also receives parameters (or event inputs) that are input by the meeting organizer. The parameters can include things such as the subject matter of the meeting, and an initial set of participants. The platform then accesses context information, based upon the parameters that are initially input, and identifies relevant context information, based upon those input parameters. Using the relevant context information, the platform automatically suggests a set of participants, and surfaces that set of participants for user interaction. The user can accept or reject those participants, or modify the suggested participant list. The user's interactions are fed back to the platform to improve its performance.

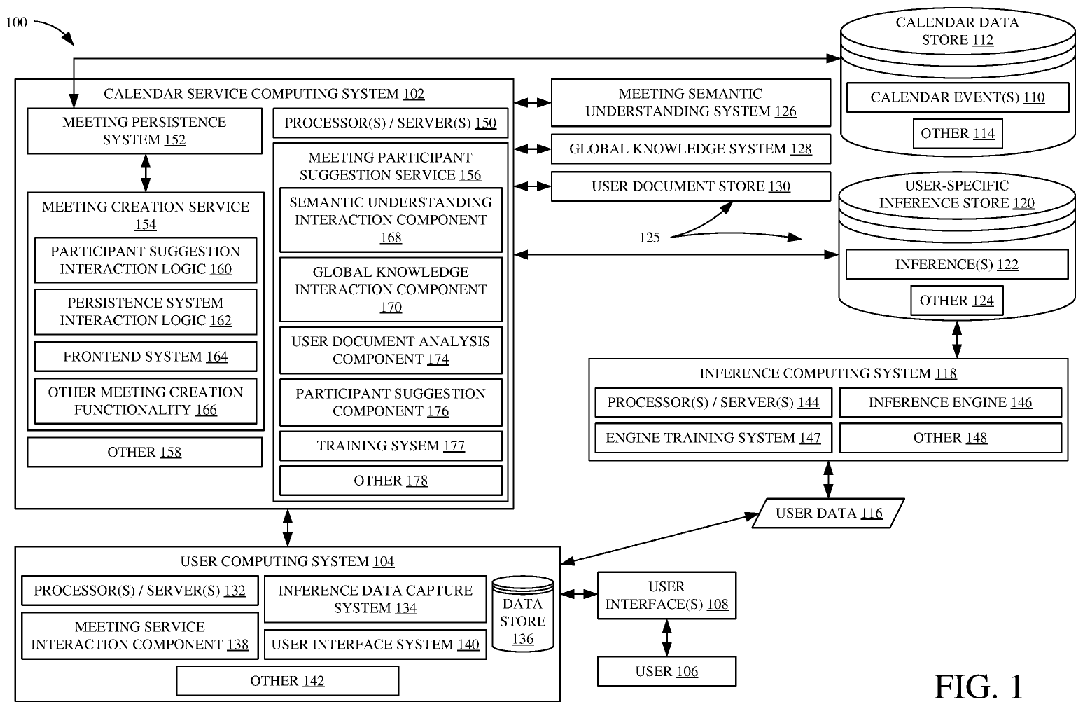

FIG. 1 is a block diagram showing one example of a computing system architecture 100 in which a calendar service computing system 102 can be accessed by a user computing system 104 so that a user 106 can schedule meetings or other calendar appointments or calendar events (which may be referred to hereinafter as calendar events or meetings). User interfaces 108 are illustratively generated by user computing system 104 for interaction by user 106. User 106 can interact with the user interfaces 108 in order to control and manipulate user computing system 104 and some parts of calendar computing system 102, in order to generate a calendar event (such as a meeting). Calendar service computing system 102 then stores (or persists) the calendar events 110 in a calendar data store 112. Data store 112 can store other items 114 as well.

In FIG. 1, system 102 is shown as having access to a set of context sources 125. These sources are described in greater detail below.

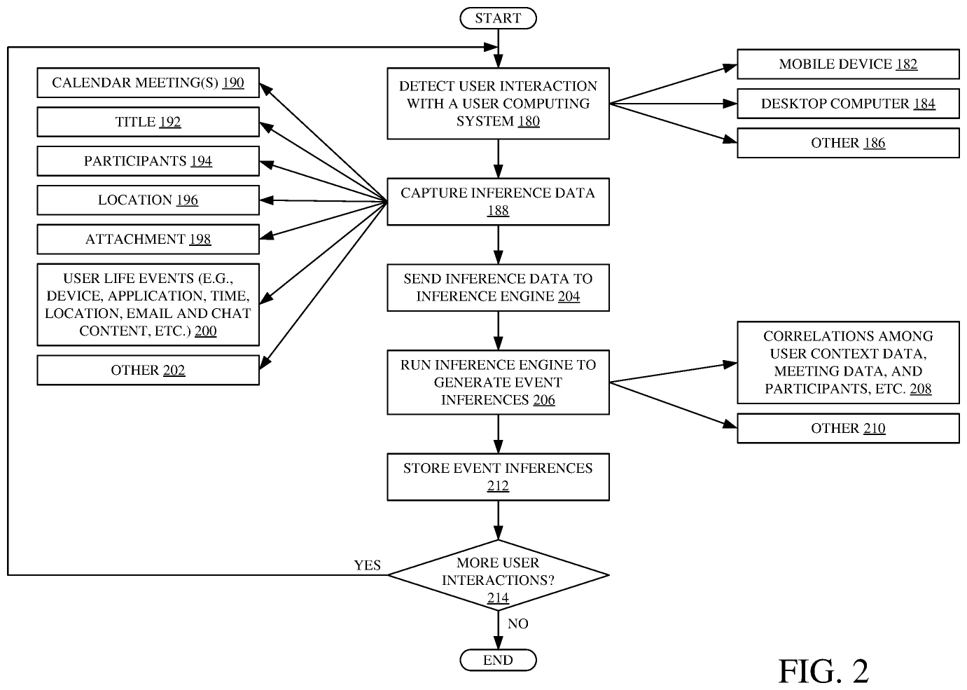

FIG. 1 also shows that user computing system 104 can provide a variety of different types of user data 116 to an inference computing system 118. Inference computing system 118 generates user-specific inferences, based upon the user data 116, and stores the inferences in user-specific inference store 120. Data store 120 shows inferences 122, and it can store other items 124 as well. The operation of the inference computing system 118 is described in greater detail below with respect to FIG. 2.

FIG. 1 also shows that calendar service computing system 102 can have access to a meeting semantic understanding system 126. System 126 can receive information indicative of a meeting (or other calendar event) and parse that information to generate a semantic understanding of the meeting. It can, for instance, suggesting participants to the meeting, a subject matter for the meeting, and a wide variety of other semantic information relative to the meeting.

FIG. 1 also shows that calendar service computing system 102 has access to a global knowledge system 128. Global knowledge system 128 can receive inferences 122 for a plurality of different users corresponding to an organization. It can store other global knowledge as well, that may be relevant to identifying participants to a meeting. While this is described in greater detail below, some examples include an organization structure that identifies how an organization is structured in terms of its personnel, team structures, an identity of various teams and groups that are formed within the organization, duties or other operational characteristics corresponding to the different roles in the organization, among other things.

FIG. 1 also shows that, in one example, calendar service computing system 102 has access to a user document store 130. User document store 130 can store documents that were authored by various different users, as well as the permissions that are granted to other users. For instance, user document store 130 may store documents, along with the different rights to that document that have been granted to different users. Some rights may include viewing rights, editing rights, collaborative rights, or other types of rights. The user document store 130 also illustratively stores an identity of who is currently collaborating on the document, who is authoring the document, who is viewing the document, who owns the document and/or who corresponds to the document in other ways, etc.

Before describing the overall operation of architecture 100, a brief description of some of the items in architecture 100 will first be provided. User computing system 104 illustratively includes one or more processors or servers 132, inference data capture system 134, data store 136, meeting service interaction component 138, user interface system 140, and it can include other items 142. Inference data capture system 134 illustratively captures user data 116 that is sent to inference computing system 118 for the generation of inferences. The inference data capture system 134 can be configured to capture a wide variety of different types of user data. For instance, when user 106 generates a meeting request or another calendar event, inference data capture system 134 illustratively captures the title, participants, time and location of the meeting. It can capture information indicative of any attachments to the meeting request (such as documents or other attachments) as well. Inference data capture system 134 also illustratively captures information regarding the workday of user 106. These things can include time, location, the particular device that user 106 is using at different times and locations, the particular applications that user 106 accesses and runs, a wide variety of information corresponding to electronic mail communications or messaging or other chat communications from user 106, etc. The information regarding communication messages (such as email and chat messages) can include the recipients of those messages, the authors of messages received by user 106, the subject matter content of those messages, the date and time when they are sent and received, the interaction (such as whether user 106 responded to an email message, read it, simply deleted it, etc.), as well as attachments to the messages. The information can also include a natural language processing output indicative of the subject matter content of the body of the messages, of any attachments to the messages, etc.

Inference data capture system 132 captures this information and provides it as user data 116 to inference computing system 118. Meeting service interaction component 138 illustratively allows user 106 to interact with calendar service computing system 102 to create meetings or other calendar appointments, to send meeting requests, etc. It will be noted that, in some examples, user computing system 104 does not need a separate meeting service interaction component 138. Instead, user computing system 104 allows user 106 to directly access the calendar service computing system 102.

User interface system 140 illustratively generates user interfaces 108 and detects user interaction with those user interfaces. It can provide an indication of the user interactions to other items in user computing system 104 and/or to calendar service computing system 102, or elsewhere.

Inference computing system 118 illustratively includes one or more processors or servers 144, inference engine 146, engine training system 147, and it can include other items 148. It will be noted that inference computing system 118 can be part of user computing system 104 or part of calendar service computing system 102, or it can be separate from both of them. FIG. 1 shows that it is separate, but this is illustrated for the sake of example only.

Inference engine 146 illustratively receives user data 116 and generates user-specific inferences and stores those user-specific inferences in user-specific inference store 120, as inferences 122. Inference engine 146 can be a rules-based engine, an artificial intelligence-based engine, a classifier, or any of a wide variety of other types of engines that receives information and generates inferences based upon that information. Engine training system 147 is illustratively a machine learning system that trains and improves inference engine 146 as engine 146 is used.

Calendar service computing system 102 illustratively includes one or more processors or servers 150, meeting persistence system 152, meeting creation service 154, meeting participant suggestion service 156, and it can include other items 158. Meeting creation service 154, itself, can include participant suggestion interaction logic 160, persistence system interaction logic 162, front end system 164, and it can include other meeting creation functionality 166.

Meeting participant suggestion service 156 illustratively includes semantic understanding interaction component 168, global knowledge interaction component 170, user document analysis component 172, inference system interaction component 174, participant suggestion component 176, training system 177, and it can include other items 178. Front end system 164 illustratively exposes an interface to user computing system 104. The interface can be called in order to perform calendar operations. These operations can include sending a meeting request, checking availability on various calendars, placing a calendar entry on a calendar, among a wide variety of other things.

Persistence system interaction logic 162 illustratively interacts with meeting persistence system 152. Logic 162 can provide data describing a meeting that is to be placed on the user's calendar (and perhaps on the calendar of other participants) to meeting persistence system 152. System 152 illustratively interacts with calendar data store 112 to store the calendar events 110 on the appropriate user calendars.

Participant suggestion interaction logic 160 illustratively interacts with front end system 164 to receive various information, relating to a meeting or calendar event, that is provided by user 106. This information can include such things as the date, time and location of the event, the title, agenda, and/or topic of the meeting, the identity of any attachments to be considered at the meeting and one or more attendees that may have been identified by user 106.

These are examples only and other inputs can be received from user 106 as well. Participant suggestion interaction logic 160 then provides this information to meeting participant suggestion service 156. Service 156 identifies a set of suggested participants, based upon the information that it has received, by accessing other content sources that may have information that may indicate who should participate in the meeting.

Semantic understand interaction component 168 illustratively provides at least some of the inputs received from participant suggestion interaction logic 160 to meeting semantic understanding system 126. System 126 illustratively parses this information to identify the semantic meaning (or a plurality of semantic concepts) represented by that information. For instance, it may generate a semantic indication of the subject matter content of the meeting, of the form or type of the meeting (such as a manager/employee review meeting, etc.), as well as other information.

Based upon the semantic understanding representation generated by system 126, global knowledge interaction component 170 accesses global knowledge system 128 to obtain any global inferences that may be helpful in identifying potential participants. For instance, based upon the initial set of attendees or participants that have been provided by user 106, and based upon a semantic understanding that the subject matter of the meeting is a team review, it may be that global knowledge system 128 provides information as to who is on the identified team, who leads the team, who supervises the team, how often they meet, etc. Global knowledge system 128 also illustratively stores information about the communication messages corresponding to user 106, such as messaging and electronic mail operations or actions performed by user 106.

User document analysis component 172 illustratively interacts with user document store 130 to obtain any additional information that may be used to suggest participants for the meeting. For instance, if there is an attachment to the meeting, or if there is a document that is to be discussed at the meeting (as indicated by the subject matter content or agenda of the meeting), then component 172 can access that document in user document store 130 to obtain information that may be useful in identifying suggested participants. It may identify authors of the document, those who are collaborating on the document, anyone who has view or edit access to the document. It may identify those who have read the document, among other things.

Based upon any or all of the information obtained by components 168, 170 and 172, inference system interaction component 174 can use that information to obtain relevant inferences 122 from user-specific inference store 120. For instance, inferences 122 may indicate that where user 106 is scheduling a meeting with a particular user to discuss a particular document, there is a high likelihood that another particular user should be suggested as a participant in that meeting. This may be because user 106 is collaborating with two other people on a document and when user 106 sends email regarding that document, user 106 always includes both of those users as a recipient.

The inferences obtained by component 174, along with the information obtained by components 168, 170 and 172 can then be provided to participant suggestion component 176. Participant suggestion component 176 can generate a list of suggested participants, along with a confidence score corresponding to each. It can provide the top N participants back to meeting creation service 154, so that front end system 164 can surface them for user interaction by user 106. It can surface all suggested participants that have a confidence score above a threshold. It can surface the suggested participants in order, ranked by confidence score from greatest to least, and/or it can surface the suggested participants in other ways. Training system 177 is illustratively a machine learning system that trains and improves component 176.

FIG. 2 is a flow diagram illustrating one example of the operation of inference computing system 118 in generating inferences 122 based on user data 116. Inference data capture system 134 first detects user interaction with a user computing system 104. This is indicated by block 180 in the flow diagram of FIG. 2. It will be noted that user computing system 104 can be a mobile device 182, a desktop computer 184, or any of a wide variety of other devices 186.

Inference data capture system 134 then captures inference data (or user data 116) based upon the user interactions. This is indicated by block 188. The user data 116 can include a wide variety of different types of information, such as information defining calendar meetings or other calendar events, as indicated by block 190. For those meetings, data 116 can include the title 192, participants 194, the location of the meeting 196, any attachments to the meeting request 198, etc. The user data (or inference data) 116 can also include a wide variety of other information such as the particular device being used. It can include the applications that are open or being used by user 106. It can include the time and location when different events occur. It can include email messages, chat content, among a wide variety of other information. This is indicated by block 200. The inference data (or user data 116) can be captured in other ways, using other mechanisms as well. This is indicated by block 202.

The user data 116 (or inference data) is then sent to inference computing system 118. This is indicated by block 204. In one example, the user data 116 is captured and buffered by inference data capture system 134, and is intermittently sent to inference computing system 118. In another example, it is sent substantially continuously (or in near real time) as it is captured. In another example, inference data capture system 134 uses trigger criteria to determine when to capture and send inference data. The trigger criteria can include certain types of user interactions, such as when the user opens certain applications or performs certain operations or tasks, or it can include other criteria.

Inference engine 146 then runs on the user data 116 to generate inferences. In one example, it generates inferences related to calendar events (such as meetings, appointments, conference calls, etc.). Running the inference engine to generate event inferences is indicated by block 206 in the flow diagram of FIG. 2. Inference engine 146 can be a rules-based engine, an engine based on artificial intelligence, a machine learning classifier, or any of a wide variety of other types of engines that generate inferences based upon received data.

The inferences, themselves, can take a wide variety of different forms. In one example, they are inferences that are geared toward providing helpful information in attempting to suggest participants to a meeting or calendar event. Therefore, they can be inferences that define correlations between meeting content and participants, between participants and other participants, between meeting time and location and participants, between the user organizing the meeting and other participants, as well as a wide variety of other inferences that can be used to identify participants to suggest for a meeting. The inferences can be correlations between different items of data, along with a confidence score indicating how confident the inference 146 is in the correlation. Thus, they can include correlations among user context data, meeting data, participants, etc. This is indicated by block 208 in the flow diagram of FIG. 2. The inferences can take a wide variety of other forms and be generated in other ways as well, and this is indicated by block 210.

Once the inferences are generated, inference engine 146 stores those inferences 122 in user-specific inference store 120. This is indicated by block 212. In one example, only the inferences that have a confidence score that it is above a certain threshold are stored. In another example, all inferences are stored and, if the confidence scores do not increase over time, those interferences can be pruned from the stored inferences. The inferences can be stored in other ways as well.

As long as user 106 continues to interact with user computing system 104, then the process reverts to block 180 where those user interactions are detected and inferences are generated. This is indicated by block 214 in the flow diagram of FIG. 2.

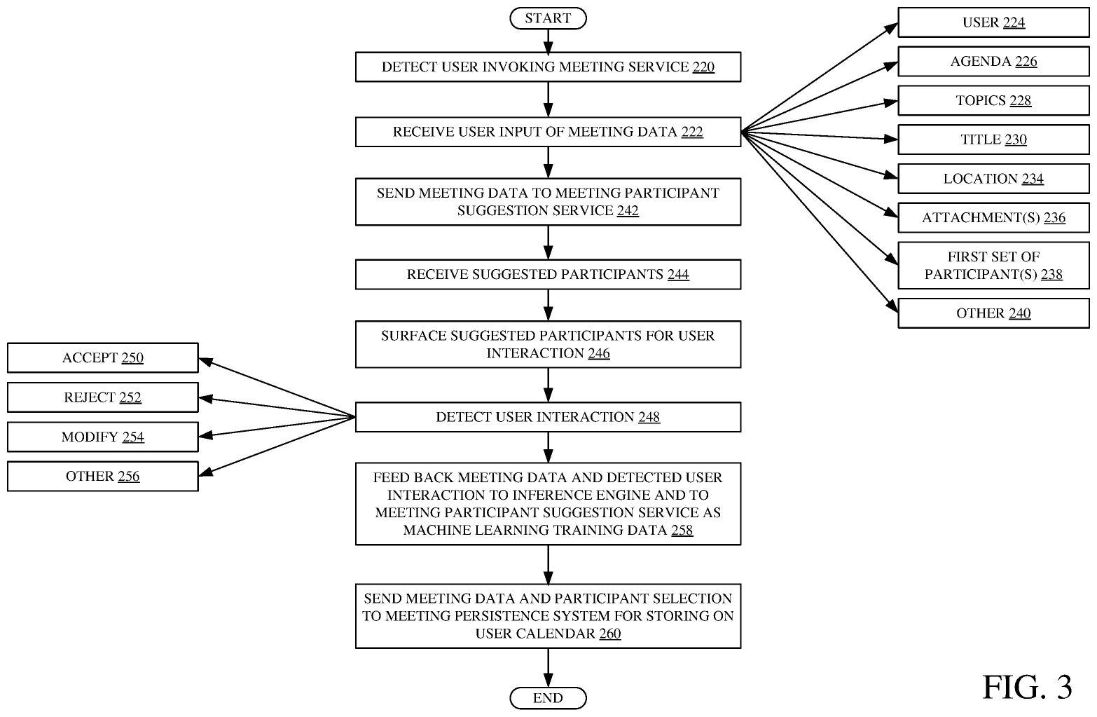

FIG. 3 is a flow diagram illustrating one example of the operation of meeting creation service 154 in receiving user inputs to create a meeting, interacting with meeting participant suggestion service 156 to suggest participants to the meeting, and in providing meeting details to meeting persistence system 152 so that the meeting (or calendar event) can be stored in calendar data store 112.

Front end system 164 first detects user 106 invoking the meeting creation service 154. This is indicated by block 220 in the flow diagram of FIG. 3. Service 154 then receives user input of meeting data. This is indicated by block 222. As discussed above, front end system 164 can expose an interface that can be called by user computing system 104 (e.g., by meeting service interaction component 138) to allow user 106 to provide information corresponding to a meeting (or other calendar event) that the user is creating. That information can include an identity of the user as indicated by block 224. It can include a meeting agenda 226, one or more topics 228 that are to be covered at the meeting, a meeting title 230, a meeting time and location 232, 234, respectively, any attachments or links to attachments that are to be considered at the meeting, as indicated by block 236, a first set of participants 136 (that may be selected or otherwise identified by user 106), and it can include a wide variety of other information 240. Some or all of the meeting data received by front end system 164 is provided to participant suggestion interaction logic 160, which sends it to meeting participant suggestion service 156. This is indicated by block 242 in the flow diagram of FIG. 3.

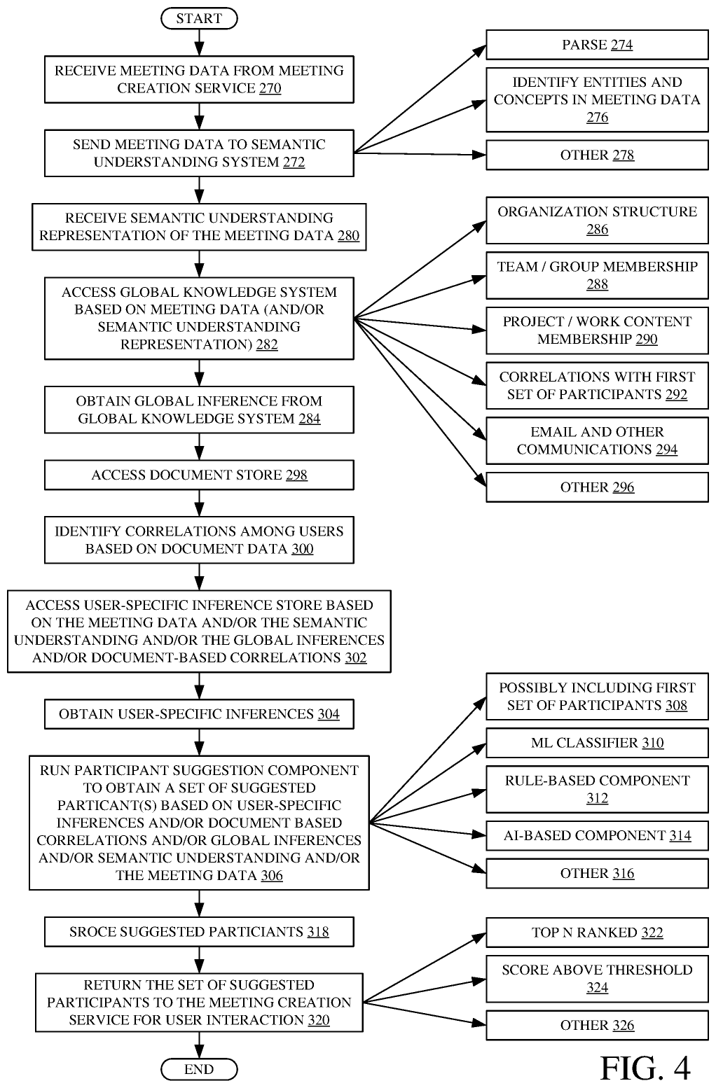

As is described in greater detail below with respect to FIG. 4, meeting participant suggestion service 156 generates a set of suggested participants that may be suggested to user 106, for adding to the meeting or meeting request. Receiving the suggested participants from service 156 is indicated by block 244 in the flow diagram of FIG. 3.

The suggested participants are then provided to front end system 164 which provides them to user computing system 104 for surfacing to user 106. In one example, they are surfaced in an interactive way so that user 106 can select one or more of the suggested participants to be added to the meeting. Also, in one example, the suggested participants may be rejected by user 106, either individually or collectively, by interacting with the list of suggested participants. Further, in one example, the suggested participants each have a corresponding confidence value associated with them, indicating how confident meeting participant suggestion service 156 is in suggesting the participant. The suggested participants can be surfaced in rank order, based upon the confidence score, or in other ways. Similarly, the top N suggested participants can be surfaced for user 106, or all suggested participants that have a sufficient confidence score (e.g., a confidence score that is above a given threshold) can be surfaced, or the suggested participants can be surfaced in other ways. Surfacing the suggested participants for user interaction is indicated by block 246 in the flow diagram of FIG. 3.

User interface system 140 then detects user interaction with the list of suggested participants. This is indicated by block 248. This user interaction can be provided to meeting service interaction component 138 and through front end system 164 back to meeting creation service 154. The user interactions can take a wide variety of different forms. The user can interact with the list of suggested participants to accept the suggestions, as indicated by block 250. The user can reject or modify the list of participants as indicated by blocks 252 and 254, respectively. The user can interact with a list of suggested participants in other ways as well, and this is indicated by block 256.

The user interaction with the list of suggested participants indicates, to some extent, how well inference computing system 118 is generating inferences and how well meeting participant suggestion service 156 is suggesting participants based upon the information that it receives. Therefore, in one example, an indication of the user interactions with the suggested participants is fed back to the engine training system 147 in inference computing system 118 and to the training system 177 in meeting participant suggestion service 156. These training systems can be machine learning training systems, artificial intelligence training systems, classifier training systems, or other training systems that can be used to train the inference engine 146 and participant suggestion component 176. The user interactions can be fed back, along with the suggested participants, as labeled training data to improve the performance of engine 146 and component 176. Feeding back the data and detected user interaction to the inference engine and the meeting participant suggestion service, as machine learning training data, is indicated by block 258 in the flow diagram of FIG. 3.

Persistence system interaction logic 162 then sends the meeting data, along with all of the selected participants (those initially identified by user 106 as well as the suggested participants that have been added to the meeting by user 106) to meeting persistence system 152. System 152 then stores the data as a calendar event 110 in the calendar data store 112 on the various calendars of the participants in the meeting. Sending the meeting data and participant selection to meeting persistence system 152 for storing on the user calendars in calendar data store 112 is indicated by block 260 in the flow diagram of FIG. 3.

FIG. 4 is a flow diagram illustrating one example of the operation of meeting participant suggestion service 156, in generating a list of suggested participants, based upon the information received from meeting creation service 154, and based upon the other context sources that service 156 accesses. As discussed above, meeting participant suggestion service 156 receives the meeting data from the meeting creation service (e.g., from participant suggestion interaction logic 160, in service 154). This is indicated by block 270 in the flow diagram of FIG. 4. Semantic understanding interaction component 168 then sends the meeting data to the meeting semantic understanding system 126. This is indicated by block 272 in the flow diagram of FIG. 4. As discussed above, system 126 can parse the data, as indicated by block 274 and identify entities and concepts and other indications of the semantic meaning of the meeting data, as indicated by block 276. The meeting semantic understanding system 126 can perform other operations as well, and this is indicated by block 278.

Semantic understanding interaction component 168 illustratively receives an indication of the semantic understanding of the meeting data. This is indicated by block 280. It can provide that semantic understanding representation to other items in meeting participant suggestion service 156.

Global knowledge interaction component 170 illustratively accesses the global knowledge system 128, based upon the meeting data received from meeting creation service 154, and it can also access system 128 based upon the semantic understand received from component 168. This is indicated by block 282 in the flow diagram of FIG. 4. Global knowledge interaction component 170 can use global knowledge system 128 to identify and obtain global inferences that can be used to suggest participants for the meeting. This is indicated by block 284.

The global inferences can include a wide variety of information. For instance, they can be inferences based upon the organization structure that may be stored in global knowledge system 128. This is indicated by block 286. They can be inferences based upon team or group membership of user 106, in the organization. This is indicated by block 288. They can be inferences based upon the involvement of user 106 in various projects and work content. This is indicated by block 290. They can be inferences based upon correlations with the first set of participants that were identified by user 106 in the meeting data. This is indicated by block 292. They can be inferences based upon email and other communication messages and conversations. This can include the content of the communications as well as the recipients, authors, and interactions of recipients, of those communications. This is indicated by block 294 in the flow diagram of FIG. 4. The global inferences can be based upon a wide variety of other information as well, and this indicated by block 296.

User document analysis component 172 accesses user document store 130 to obtain information that may be useful to participant suggestion component 176 in suggesting participants for the meeting. This is indicated by block 298. User document analysis component 172 illustratively identifies correlations among users based on document data (such as who authored different documents, who participated or collaborated in authoring documents that are to be discussed at the meeting, who collaborated on documents that relate to the subject matter content of the meeting, among other things. Identifying correlations among users based on document data is indicated by block 300 in the flow diagram of FIG. 4.

Inference system interaction component 174 then accesses the user-specific inference store 120 based on the meeting data and/or the semantic understanding and/or the global inferences and/or the document-based correlations. This is indicated by block 302. It can obtain user-specific inferences 122, based upon that information. This is indicated by block 304.

Thus, in one example, all of the context sources 125 can provide context information that can be used to obtain a correlation among users. The correlations can be correlations of users 106 to other users or among the meeting participants initially identified by user 106 to other users, or other correlations.

Participant suggestion component 176 then runs based on the user-specific inferences and/or the document-based correlations and/or the global inferences and/or the semantic understanding of the meeting information and/or the meeting data itself. In doing so, it illustratively identifies correlations among users and, based on those correlations, identifies a set of suggested participants that are to be surfaced for interaction by user 106. Running the participant suggestion component to obtain the set of suggested participants is indicated by block 306 in the flow diagram of FIG. 4. Again, participant suggestion component 176 can generate the list of suggested participants to include the first set of participants that were already identified by user 106, or it can output only the new suggested participants that were not previously identified by user 106. This is indicated by block 308 in the flow diagram of FIG. 4. Also, component 174 can be a machine learning classifier as indicated by block 310. It can be a rule-based component as indicated by block 312 or an artificial intelligence-based component 314. It can be a wide variety of other components or combinations of components as well. This is indicated by block 316.

In one example, participant suggestion component 176 also scores each of the suggested participants. The score may be related to a confidence which component 176 has with respect to the suggested participant. The score can be generated in other ways as well. Scoring the suggested participants is indicated by block 318 in the flow diagram of FIG. 4.

Participant suggestion component 176 then returns the set of suggested participants to the meeting creation service 184, for user interaction by user 106. This is indicated by block 320. In one example, component 176 returns the top N suggested participants, ranked based on the score that was generated for them. This is indicated by block 322. In another example, component 176 returns all suggested participants that have a score above a threshold score. This is indicated by block 324. In another example, component 176 can return the suggested participants in other ways as well. This is indicated by block 326.

The present discussion thus improves the accuracy of calendar events 110 that are eventually stored in calendar data store 112. It reduces network bandwidth in that user 106 need not access different sources in an attempt to obtain the identity of participants that should be included in the meeting or calendar event. Also, the system is dynamic in that when new participants are added to the organization, the inferences and other information related to those new participants are already captured in the system.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

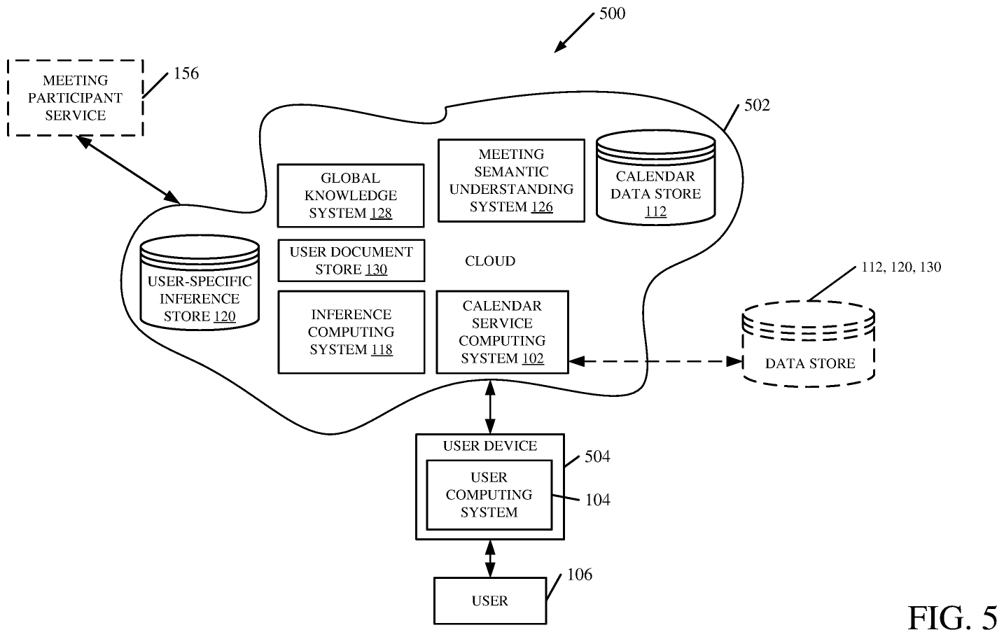

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 5, some items are similar to those shown in FIG. 1 and they are similarly numbered. FIG. 5 specifically shows that calendar service computing system 102 as well as systems 118, 126, 128 and data stores 112, 120 and 130 can be located in cloud 502 (which can be public, private, or a combination where portions are public while others are private). Therefore, user 106 uses a user device 504 to access those systems through cloud 502.

FIG. 5 also depicts another example of a cloud architecture. FIG. 5 shows that it is also contemplated that some elements of computing system 102 can be disposed in cloud 502 while others are not. By way of example, data stores 112, 120 and 130 can be disposed outside of cloud 502, and accessed through cloud 502. In another example, service 156, or other items, can be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

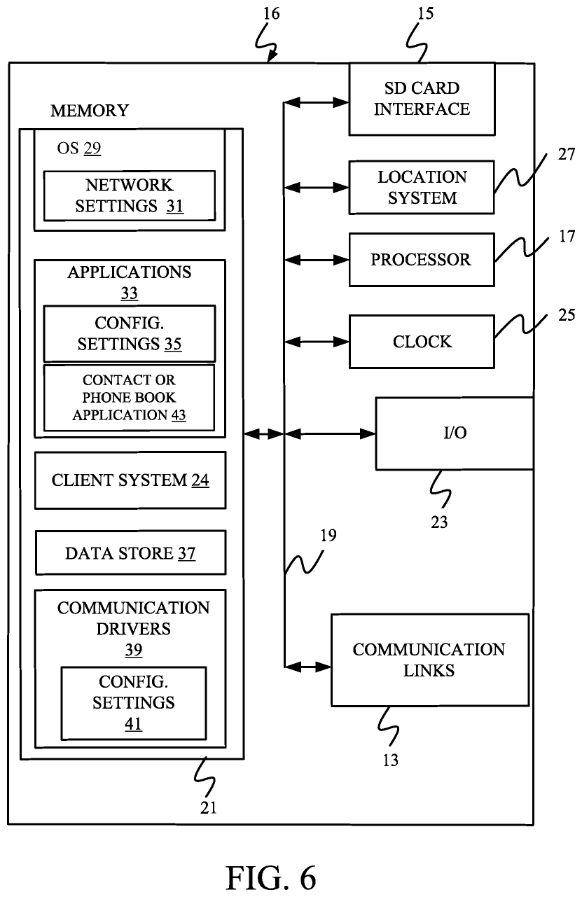

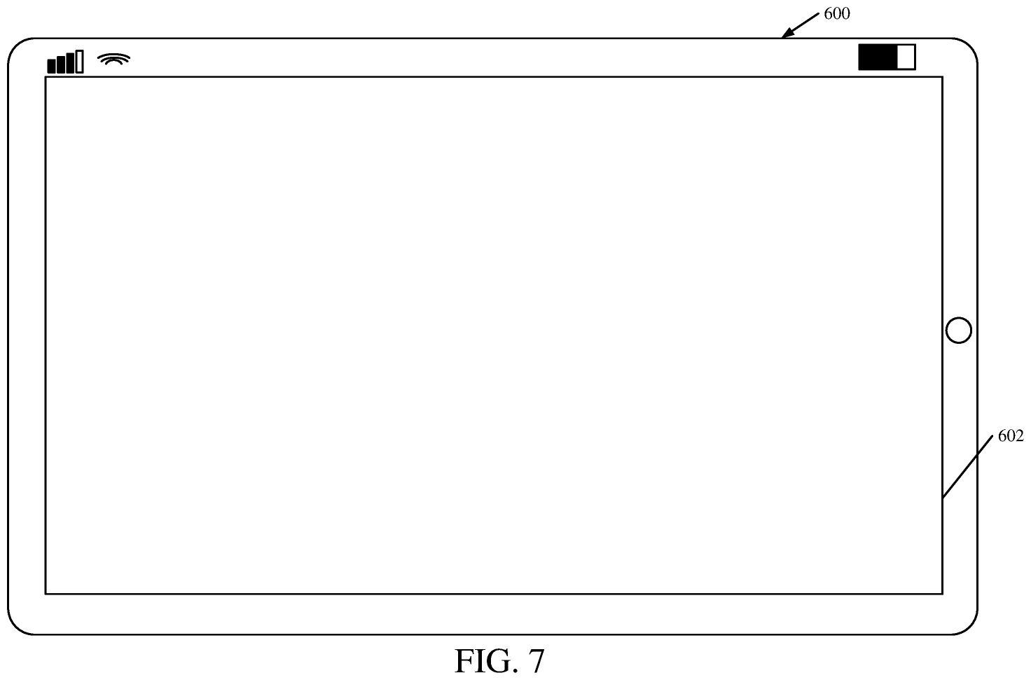

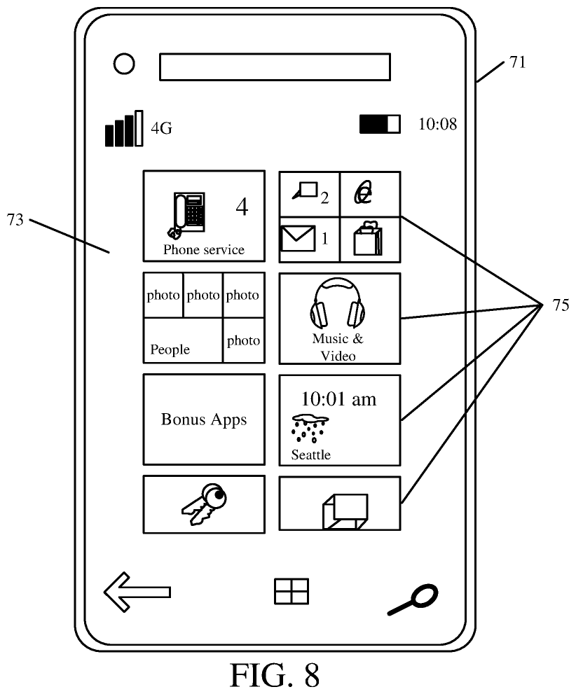

FIG. 6 is a simplified block diagram of one illustrative example of a handheld or mobile computing device that can be used as a user's or client's hand held device 16, in which the present system (or parts of it) can be deployed. FIGS. 7-8 are examples of handheld or mobile devices.

FIG. 6 provides a general block diagram of the components of a client device 16 that can run components computing system 102 or user device 504 or system 116 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one embodiment, are provided to facilitate input and output operations. I/O components 23 for various examples of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one example in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 8 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

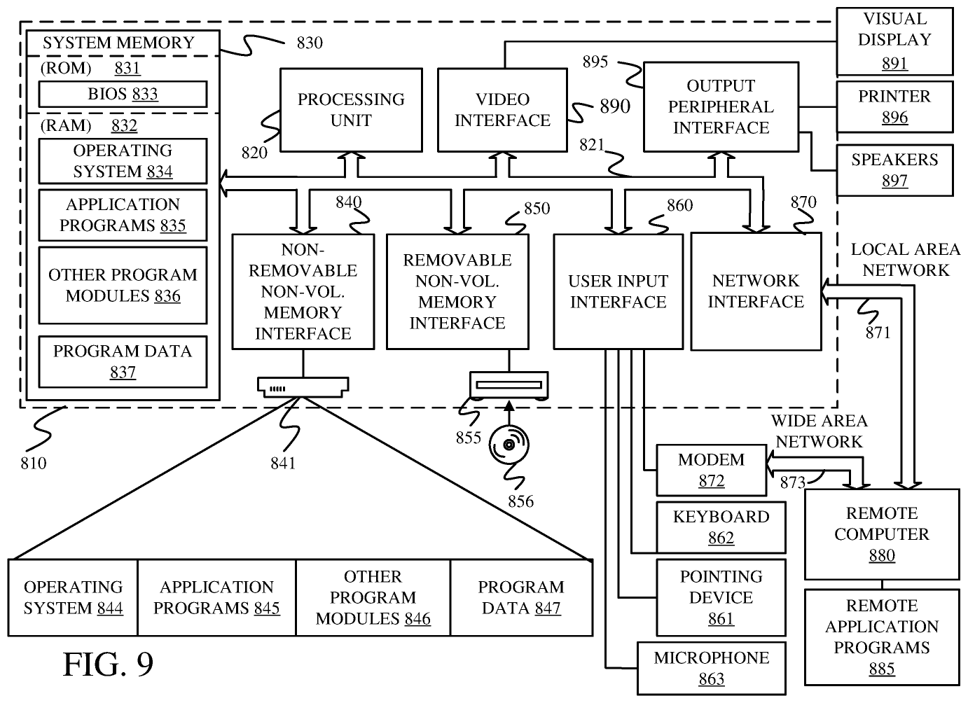

FIG. 9 is one example of a computing environment in which architecture 100, or parts of it, (for example) can be deployed. With reference to FIG. 9, an example system for implementing some embodiments includes a computing device, programmed or configured to operate as described above, in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computer implemented method, comprising:

receiving event user input data, input by a user through a user interface, indicative of a first set of parameters of a calendar event;

accessing a context data source to obtain context parameters based on the first set of parameters;

identifying a set of suggested participants based on the first set of parameters and the context parameters; and

providing the set of suggested participants on a user interface, for user selection, to add one or more suggested participants, in the set of selected participants, as participants in the calendar event.

Example 2 is the computer implemented method of any or all previous examples and further comprising:

detecting user interaction selecting a suggested participant in the set of selected participants; and

adding the selected suggested participant to the calendar event.

Example 3 is the computer implemented method of any or all previous examples wherein receiving event user input data comprises:

receiving an indication of a first set of participants identified by the user.

Example 4 is the computer implemented method of any or all previous examples wherein accessing a context data source comprises:

accessing a context data source that identifies context data indicative of correlations between the user and other users based on membership in a group of users; and

obtaining the correlations between the user and other users based on membership in a group of users.

Example 5 is the computer implemented method of any or all previous examples wherein accessing a context data source comprises:

accessing a context data source that identifies context data indicative of correlations between the user and other users based on an organization structure of an organization to which the user belongs; and

obtaining the correlations between the user and other users based on an organization structure of an organization to which the user belongs.

Example 6 is the computer implemented method of any or all previous examples wherein accessing a context data source comprises:

accessing a context data source that identifies context data indicative of correlations between the user and other users based on communication actions of the user; and

obtaining the correlations between the user and other users based on communication actions of the user.

Example 7 is the computer implemented method of any or all previous examples wherein accessing a context data source comprises:

accessing a context data source that identifies context data indicative of correlations between the user and other users based on recipients the user identifies in communication messages; and

obtaining the correlations between the user and other users based on recipients the user identifies in communication messages.

Example 8 is the computer implemented method of any or all previous examples wherein accessing a context data source comprises:

accessing a context data source that identifies context data indicative of correlations between the user and other users based on authors of communication messages that the user receives and interacts with; and

obtaining the correlations between the user and other users based on authors of communication messages that the user receives and interacts with.

Example 9 is the computer implemented method of any or all previous examples wherein accessing a context data source comprises:

accessing a context data source that identifies context data indicative of correlations between the user and other users based on substantive content of communication messages sent and received by the user; and

obtaining the correlations between the user and other users based on substantive content of communication messages sent and received by the user.

Example 10 is the computer implemented method of any or all previous examples wherein the event user input data is indicative of a subject matter of the calendar event and wherein accessing a context data source comprises:

accessing a context data source that identifies context data indicative of correlations between the user and other users based on the subject matter of the meeting indicated by the event user input data; and

obtaining the correlations between the user and other users based on the subject matter of the meeting indicated by the event user input data.

Example 11 is the computer implemented method of any or all previous examples wherein accessing a context source comprises:

providing the first set of parameters to a semantic understanding system;

obtaining a semantic representation, indicative of a semantic understanding of the first set of parameters, from the semantic understanding system;

accessing a context data source that provides context data indicative of a correlation between the user and other users based on the semantic representation; and

obtaining the correlation between the user and other users based on the semantic representation.

Example 12 is the computer implemented method of any or all previous examples wherein accessing a context source comprises:

accessing a context data source that provides context data indicative of a correlation between the user and other users based on documents associated with the user; and

obtaining the correlation between the user and other users based on the documents associated with the user.

Example 13 is a computing system, comprising:

one or more processors;

memory storing instructions which, when executed by the one or more processors, cause the one or more processors to perform steps of:

receiving meeting user input data, input by a user, indicative of a first set of parameters of a meeting;

accessing a context data source to obtain context parameters based on the first set of parameters;

identifying a set of suggested participants based on the first set of parameters and the context parameters; and

providing the set of suggested participants for output on a user interface for user selection to add one or more suggested participants, in the set of selected participants, as participants in the meeting.

Example 14 is the computing system of any or all previous examples wherein the instructions further cause the one or more processors to perform steps of:

detecting user interaction selecting a suggested participant in the set of selected participants; and

adding the selected suggested participant to the meeting.

Example 15 is the computing system of any or all previous examples wherein the meeting user input data is indicative of a subject matter of the meeting and wherein accessing a context data source comprises:

accessing a context data source that identifies context data indicative of correlations between the user and other users based on the subject matter of the meeting indicated by the meeting user input data; and

obtaining the correlations between the user and other users based on the subject matter of the meeting indicated by the meeting user input data.

Example 16 is the computing system of any or all previous examples wherein accessing a context source comprises:

providing the first set of parameters to a semantic understanding system;

obtaining a semantic representation, indicative of a semantic understanding of the first set of parameters, from the semantic understanding system;

accessing a context data source that provides context data indicative of a correlation between the user and other users based on the semantic representation; and

obtaining the correlation between the user and other users based on the semantic representation.

Example 17 is the computing system of any or all previous examples wherein accessing a context source comprises:

accessing a context data source that provides context data indicative of a correlation between the user and other users based on documents associated with the user; and

obtaining the correlation between the user and other users based on the documents associated with the user.

Example 18 is a computing system, comprising:

one or more processors;

memory storing instructions which, when executed by the one or more processors, cause the one or more processors to implement:

a context parameter generator that receives meeting user input data, input by a user, indicative of a first set of parameters of a meeting and accessing a context data source to obtain context parameters based on the first set of parameters;

a participant suggestion component that identifies a set of suggested participants based on the first set of parameters and the context parameters; and

a front end system that provides the set of suggested participants for output on a user interface for user selection to add one or more suggested participants, in the set of selected participants, as participants in the meeting.

Example 19 is the computing system of any or all previous examples wherein the meeting user input data is indicative of a subject matter of the meeting and wherein the context parameter generator is configured to accessing a context data source that identifies context data indicative of correlations between the user and other users based on the subject matter of the meeting indicated by the meeting user input data and to obtain the correlations between the user and other users based on the subject matter of the meeting indicated by the meeting user input data.

Example 20 is the computing system of any or all previous examples wherein the context parameter generator is configured to access a context data source that provides context data indicative of a correlation between the user and other users based on documents associated with the user and to obtain the correlation between the user and other users based on the documents associated with the user and wherein the context parameter generator is further configured to access a context data source that identifies context data indicative of correlations between the user and other users based on communication actions of the user and to obtain the correlations between the user and other users based on communication actions of the user.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
receiving event user input data, input by a user through a user interface, indicative of a first set of parameters of a calendar event;
accessing a context data source to obtain context parameters based on the first set of parameters;
identifying a set of suggested participants based on the first set of parameters and the context parameters; and
providing the set of suggested participants on a user interface, for user selection, to add one or more suggested participants, in the set of selected participants, as participants in the calendar event.

2. The computer implemented method of claim 1 and further comprising:
detecting user interaction selecting a suggested participant in the set of selected participants; and
adding the selected suggested participant to the calendar event.

3. The computer implemented method of claim 1 wherein receiving event user input data comprises:
receiving an indication of a first set of participants identified by the user.

4. The computer implemented method of claim 3 wherein accessing a context data source comprises:
accessing a context data source that identifies context data indicative of correlations between the user and other users based on membership in a group of users; and
obtaining the correlations between the user and other users based on membership in a group of users.

5. The computer implemented method of claim 3 wherein accessing a context data source comprises:
accessing a context data source that identifies context data indicative of correlations between the user and other users based on an organization structure of an organization to which the user belongs; and
obtaining the correlations between the user and other users based on an organization structure of an organization to which the user belongs.

6. The computer implemented method of claim 3 wherein accessing a context data source comprises:
accessing a context data source that identifies context data indicative of correlations between the user and other users based on communication actions of the user; and
obtaining the correlations between the user and other users based on communication actions of the user.

7. The computer implemented method of claim 6 wherein accessing a context data source comprises:
accessing a context data source that identifies context data indicative of correlations between the user and other users based on recipients the user identifies in communication messages; and
obtaining the correlations between the user and other users based on recipients the user identifies in communication messages.

8. The computer implemented method of claim 6 wherein accessing a context data source comprises:
accessing a context data source that identifies context data indicative of correlations between the user and other users based on authors of communication messages that the user receives and interacts with; and
obtaining the correlations between the user and other users based on authors of communication messages that the user receives and interacts with.

9. The computer implemented method of claim 6 wherein accessing a context data source comprises:
accessing a context data source that identifies context data indicative of correlations between the user and other users based on substantive content of communication messages sent and received by the user; and
obtaining the correlations between the user and other users based on substantive content of communication messages sent and received by the user.

10. The computer implemented method of claim 1 wherein the event user input data is indicative of a subject matter of the calendar event and wherein accessing a context data source comprises:
accessing a context data source that identifies context data indicative of correlations between the user and other users based on the subject matter of the meeting indicated by the event user input data; and
obtaining the correlations between the user and other users based on the subject matter of the meeting indicated by the event user input data.

11. The computer implemented method of claim 1 wherein accessing a context source comprises:
providing the first set of parameters to a semantic understanding system;
obtaining a semantic representation, indicative of a semantic understanding of the first set of parameters, from the semantic understanding system;
accessing a context data source that provides context data indicative of a correlation between the user and other users based on the semantic representation; and
obtaining the correlation between the user and other users based on the semantic representation.

12. The computer implemented method of claim 1 wherein accessing a context source comprises:
accessing a context data source that provides context data indicative of a correlation between the user and other users based on documents associated with the user; and
obtaining the correlation between the user and other users based on the documents associated with the user.

13. A computing system, comprising:
one or more processors;
memory storing instructions which, when executed by the one or more processors, cause the one or more processors to perform steps of:
receiving meeting user input data, input by a user, indicative of a first set of parameters of a meeting;
accessing a context data source to obtain context parameters based on the first set of parameters;
identifying a set of suggested participants based on the first set of parameters and the context parameters; and
providing the set of suggested participants for output on a user interface for user selection to add one or more suggested participants, in the set of selected participants, as participants in the meeting.

14. The computing system of claim 13 wherein the instructions further cause the one or more processors to perform steps of:
detecting user interaction selecting a suggested participant in the set of selected participants; and
adding the selected suggested participant to the meeting.

15. The computing system of claim 13 wherein the meeting user input data is indicative of a subject matter of the meeting and wherein accessing a context data source comprises:
accessing a context data source that identifies context data indicative of correlations between the user and other users based on the subject matter of the meeting indicated by the meeting user input data; and
obtaining the correlations between the user and other users based on the subject matter of the meeting indicated by the meeting user input data.

16. The computing system of claim 13 wherein accessing a context source comprises:
providing the first set of parameters to a semantic understanding system;
obtaining a semantic representation, indicative of a semantic understanding of the first set of parameters, from the semantic understanding system;
accessing a context data source that provides context data indicative of a correlation between the user and other users based on the semantic representation; and
obtaining the correlation between the user and other users based on the semantic representation.

17. The computing system of claim 13 wherein accessing a context source comprises:
accessing a context data source that provides context data indicative of a correlation between the user and other users based on documents associated with the user; and
obtaining the correlation between the user and other users based on the documents associated with the user.

18. A computing system, comprising:
one or more processors;
memory storing instructions which, when executed by the one or more processors, cause the one or more processors to implement:
a context parameter generator that receives meeting user input data, input by a user, indicative of a first set of parameters of a meeting and accessing a context data source to obtain context parameters based on the first set of parameters;
a participant suggestion component that identifies a set of suggested participants based on the first set of parameters and the context parameters; and
a front end system that provides the set of suggested participants for output on a user interface for user selection to add one or more suggested participants, in the set of selected participants, as participants in the meeting.

19. The computing system of claim 18 wherein the meeting user input data is indicative of a subject matter of the meeting and wherein the context parameter generator is configured to accessing a context data source that identifies context data indicative of correlations between the user and other users based on the subject matter of the meeting indicated by the meeting user input data and to obtain the correlations between the user and other users based on the subject matter of the meeting indicated by the meeting user input data.

20. The computing system of claim 18 wherein the context parameter generator is configured to access a context data source that provides context data indicative of a correlation between the user and other users based on documents associated with the user and to obtain the correlation between the user and other users based on the documents associated with the user and wherein the context parameter generator is further configured to access a context data source that identifies context data indicative of correlations between the user and other users based on communication actions of the user and to obtain the correlations between the user and other users based on communication actions of the user.
